(19) United States
(12) Patent Application Publication
(10) Pub. No.: US 2022/0134519 A1
(43) Pub. Date: May 5, 2022

(54) Fastener Identifying Mechanism for Attachment Tool

(71) Applicant: OMG, Inc., Agawam, MA (US)

(72) Inventors: Peter J. Shadwell, Longmeadow, MA (US); Cedric Delmy, Chicopee, MA (US); Kurt Michael Maw, Salem, MA (US); Catherine Hildersley, Boston, MA (US); Joshua S. Kelly, Longmeadow, MA (US)

(21) Appl. No.: 17/514,645

(22) Filed: Oct. 29, 2021

Related U.S. Application Data
(60) Provisional application No. 63/107,667, filed on Oct. 30, 2020.
(60) Provisional application No. 63/109,053, filed on Nov. 3, 2020.

(51) Int. Cl. B25B 23/08; B25B 29/00

(52) U.S. Cl. CPC B25B 23/08; B25B 29/00

(57) ABSTRACT

A fastener identifying unit for use within an installation tool, has one or more movable jaws associated with a barrel. At least one jaw includes an identification member that changes position when the respective jaw moves or is actuated. The jaws are movable relative to the barrel and define a fastener receiving section, which may be an interface between a pair of jaws. The jaws are biased in a relative direction maintaining the identification member in a first position when a fastener is not present in the barrel. When a fastener is inserted into the barrel, the tip is received by the receiving section, which thereby causes the one or more movable jaws to move against the bias and the identification member to shift to a second position. The identification member is viewable by an installer in the second position to notify the installer of the presence of the fastener.

### BACKGROUND

This disclosure relates generally to a fastener driving tool and more particularly to a mechanism that acts mechanically to accurately identify presence of a fastener in a chamber before driving into a building member a portable-type screwdriver where fasteners are automatically fed to a driving position.

A variety of tools exist that are used for driving fasteners (typically rotatably driving threaded fasteners, but not limited as such), wherein the fasteners are automatically fed to a position beneath a driving spindle prior to the next operating stroke initiated by an installer. For example, the Accutrac® and Rhinotrac® tools sold by OMG, Inc. of Agawam, Mass. is one such tool that is specifically used for driving fasteners to attach roofing plates to a roof substructure. The Accutrac® tool is configured with a lower base and an elongated barrel which enables an installer to drive fasteners into the building structure while remaining standing in a substantially upright position, rather than bending over or kneeling. While the Accutrac® tool is configured especially for installation of roofing plates, comparable tools or systems with elongated barrels or other lengthy tubular structures exist in the building industries for improving reach and ergonomics.

In a typical use, an installer drops a fastener from an upper position through an inlet opening, which may be in in a separate guide tube or in the barrel itself, and the fastener falls into a driving position aligned in the barrel beneath the spindle or driver for attachment. A common drawback exists in that a user does not always know whether or may forget that a fastener is loaded into the barrel. As such, users commonly drop an additional fastener into the barrel when a first fastener is already loaded, which results in a jam within the tool.

Alert or notification systems exist wherein presence of a fastener or similar building hardware in a loaded position initiates an electrical signal that notifies an installer via activation of a light or a sound. These systems are inherently complicated, prone to failure due to the electrical circuitry and expensive and time consuming to manufacture.

It would thus be useful to have a system that provides a notification to the installer upon loading of a fastener into the driving position that operates more simply than known notification systems, for example, a notification system that operates entirely mechanically.

### SUMMARY

In one embodiment, a tool with a barrel for driving fasteners comprises a fastener identifying unit positioned toward the bottom of the tool. The fastener identifying unit has two opposing jaws attached in a pivotal relationship relative to one another and at least one opposing jaw includes an identifying portion on a surface threof. The opposing jaws are biased toward a closed position in which the identifying portion is in a first position. When a fastener is absent from the barrel of the tool, the jaws are maintained in the closed position. When a fastener is present in the barrel of the tool, the fastener mechanically causes the at least one jaw that is pivotable to pivot from the closed position against the bias to an opened position with the identifying portion in a second position viewable by an individual from an installation position.

In another embodiment, a tool for driving fasteners into a building member has an elongate barrel and two opposing jaws. The elongate barrel has a top proximal end and an opposite distal outlet proximate a nosepiece. The two opposing jaws are positioned toward the distal outlet. Each jaw has an opposing edge aligned with the outlet. At least one jaw is pivotable relative to the barrel and defines an identification member. When a fastener is present in the barrel with a tip portion at the outlet, the fastener mechanically causes the pivotable jaw to pivot outward from a first position to a second position to expose at least a portion of the identification member for view by a user from a position toward the top proximal end of the barrel, thereby notifying a user that the fastener is present in the barrel.

In yet another embodiment, a tool for driving fasteners into a building member includes an elongate barrel, and a first jaw and second jaw. The elongate barrel extends from a proximal end to a distal end with an outlet and defines a longitudinal axis. The first jaw and the second jaw are positioned distal of the proximal end of the barrel. The first jaw has a first edge and the second jaw has a second edge opposing the first edge at an interface that defines a fastener receipt section substantially aligned with the longitudinal axis. One or both of the first jaw and second jaw is shiftable relative to the barrel, which one or both shiftable jaw defines an identification member. When a fastener is received within the barrel, a tip portion of the fastener engages the receipt section and causes the one or both shiftable jaw to shift with the identification member moving outward from a first position to a second position. The moving of the identification member to the second position is viewable by a user from the proximal end of the barrel, thereby notifying a user that the fastener is present within the barrel.

In some embodiments, one or both of the jaws may include an identifying portion on an outer surface thereof.

In some embodiments, the identifying portion may be concealed from view by an individual from the position toward the top of the tool in the first or closed position.

In some embodiments, the identifying portion may be a reflective material or coating on a respective surface on which it is located.

In some embodiments, the biasing force may be provided by a bias member selected from an O-ring wrapped around a portion of the jaws and a torsion spring.

In some embodiments, the biasing force may be provided by weighting in portions of the jaw members acted upon by gravity.

In some embodiments, a bit of the tool may cause further expansion of the jaws against the bias to a driving position that allows the fastener to be driven from the barrel and into a building member by the bit.

In some embodiments, retraction of the bit into the barrel after driving the fastener into the building member may allow the jaws to return to the closed position under the bias.

In some embodiments, one or both of the jaws may comprise a nub proximate an apex that allows a user to mechanically pivot the jaws outward by human action via application of a force on the nub.

In some embodiments, each jaw may comprise an upper nub proximate an apex between a respective front arm and a respective lower leg and the jaws can be rotated by human action via pinching the nubs inward toward one another.

In some embodiments, each jaw may have a generally L-shaped cross section with a respective front arm and a respective lower leg and are configured as substantially mirror images of one another. Each front arm may include a respective front edge that opposes an opposite front edge of the front arm of the other jaw, and the front edges may combine to define a receiving section for a tip of a fastener.

In some embodiments, the front edges of the front arms of the jaws may include a chamfered surface.

In some embodiments, when a fastener is present in the barrel, the tip is received by the receiving section, thereby causing the jaws to pivot outward from the closed position to the opened position.

Some embodiments may include a viewing window toward the bottom. The identifying portion may be viewable from above through the window when in its second position.

In some embodiments, the viewing window may be formed by a cutout in an outer surface of the tool.

In some embodiments, the identifying portion may be viewable in the second position via exposure laterally from underneath an overhang in the tool.

In some embodiments, one or both of the jaws may be pivotally attached to the nosepiece distal of the outlet of the barrel.

In some embodiments, the nosepiece may include a viewing window through which the identification member is visible by a user from the top proximal end at least in the second position.

In some embodiments, the nosepiece may include a cutout that forms a viewing window through which the identification member is visible by a user from the top proximal end at least in the second position.

In some embodiments, the opposing jaws may be completely distal to the outlet of the barrel.

In some embodiments, the opposing jaws may be secured to the nose piece in a pivotable engagement.

In some embodiments, each of the jaws may be pivotable and both pivot outward when a fastener is present in the barrel with a portion at the outlet.

In some embodiments, the jaws may have a substantially L-shaped cross-sectional shape with each jaw comprising a front arm extending inward from a lower leg.

In some embodiments, each jaw may comprise a nub proximate an apex between the front arm and lower leg and the jaws can be rotated via pinching the nubs inward.

In some embodiments, one or both jaws may include a chamfered surface on an inner edge for assisting receipt of a tip of a fastener from the barrel.

In some embodiments, the pivotable jaws may be biased into an inward rotational position with one or more of the identification members concealed from view from above.

In some embodiments, the biasing force is provided by a bias member selected from an O-ring wrapped around a portion of the jaw and a torsion spring.

In some embodiments, one or both of the first jaw and the second jaw may be biased toward the first position.

In some embodiments, one or both of the first jaw and second jaw that is shiftable may be pivotally secured to the tool.

In some embodiments, the tool may comprise a nose piece distal of the barrel with the one or both of the first jaw and second jaw that is shiftable is attached to the nosepiece.

In some embodiments, the nose piece may define an outlet of the tool through which a fastener is drivable, the outlet being distal of the receipt section.

In some embodiments, the one or both of the first jaw and second jaw that is shiftable is pivotally attached to the nosepiece.

In some embodiments, the first jaw is chamfered at the first edge and the second jaw is chamfered at the second end to define the receipt section.

In some embodiments, each of the first jaw and the second jaw is pivotal relative to the barrel.

In some embodiments, a portion of one of the jaws may overlap with a portion of the other jaw.

In some embodiments, one jaw may include forward extending fingers from its arm member. The other jaw may include an undercut in its are member, and the fingers may nest beneath the undercut.

In some embodiments, one or both of the jaws may be formed from a metal alloy. In some embodiments, the metal alloy may comprise aluminum.

### BRIEF DESCRIPTION OF THE DRAWINGS

FIG. 1 is a top perspective view of portions of a roofing plate attachment tool within which the disclosed fastener identifying unit is used;

FIG. 2 is another top perspective view of portions of a roofing tool within which the disclosed fastener identifying unit is used;

FIG. 3A shows the fastener attachment unit with an unloaded barrel;

FIG. 3B shows the fastener attachment unit with a loaded barrel;

FIG. 4 depicts a roofing plate attachment tool within which the disclosed fastener identifying unit is used;

FIGS. 5A-5C show general operational steps of the disclosed fastener identifying unit;

FIG. 6 is a side cross-sectional view showing the fastener identifying unit and barrel of an exemplary tool;

FIG. 7 is a top perspective view of the fastener identifying unit and barrel;

FIG. 8 is an enlarged cross-sectional view of the fastener identifying unit;

FIG. 9 is a top elevation view of the fastener identifying unit;

FIG. 10 is a top perspective view of the fastener identifying unit;

FIG. 11 is a bottom elevation view of the fastener identifying unit;

FIG. 12 is a top perspective view of another embodiment of the fastener identifying unit with a representative fastener in the loaded position;

FIG. 13 is a side perspective partial cross-sectional view of the fastener identifying unit and barrel of FIG. 7;

FIG. 14 shows an exemplary roofing plate for attachment to a roof using a tool with the disclosed fastener identifying tool;

FIG. 15 shows an alternate embodiment of the jaws and bias member of the fastener identifying unit with the remainder of the tool hidden from view;

FIG. 16 is a bottom perspective view of the jaws and bias member of FIG. 15;

FIG. 17 is a top perspective view of nosepiece that includes the jaws of FIG. 15;

FIG. 18 is a side elevation view of the nosepiece of FIG. 17;

FIG. 19 is rear elevation view of the nosepiece of FIG. 17;

FIG. 20 is a cross sectional view of the fastener identifying unit of FIG. 17;

FIG. 21 is a cross sectional view of the jaws of FIG. 20 with the nosepiece hidden from view; and

FIG. 22 is a top elevation view of the fastener identifying unit of FIG. 17.

### DETAILED DESCRIPTION

Among the benefits and improvements disclosed herein, other objects and advantages of the disclosed embodiments will become apparent from the following wherein like numerals represent like parts throughout the several figures. Detailed embodiments of a fastener identification system are disclosed; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrase “in some embodiments” as used herein does not necessarily refer to the same embodiment(s), though it may. The phrases “in another embodiment” and “in some other embodiments” as used herein do not necessarily refer to a different embodiment, although it may. Thus, as described below, various embodiments may be readily combined, without departing from the scope or spirit of the invention.

In addition, as used herein, the term “or” is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

Further, the terms “substantial,” “substantially,” “similar,” “similarly,” “analogous,” “analogously,” “approximate,” “approximately,” and any combination thereof mean that differences between compared features or characteristics is less than 25% of the respective values/magnitudes in which the compared features or characteristics are measured and/or defined.

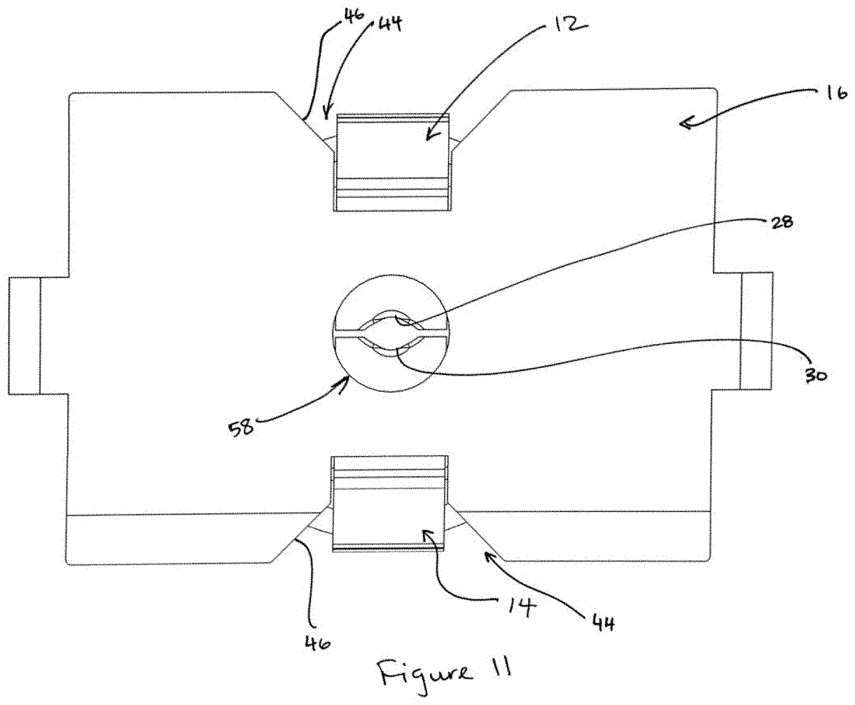

As shown in the Figures, a preferred embodiment of a fastener identifying unit 10 is positioned within the nose assembly of a fastener driving tool 300 and primarily comprises two opposing jaw members, 12 and 14. In this embodiment, each of the jaw members 12 and 14 is maintained within the nosepiece body 16 in a pivotable relationship about a separate axis defined by a respective pin 18. As shown in the cross-sectional views of FIGS. 6 and 8, in a preferred embodiment, the jaw members have a generally L-shaped cross-section with a respective inwardly extending front arm 20 and 22 and respective downwardly extending lower leg 24 and 26. Each arm extends substantially perpendicular or at least obliquely to its respective leg.

One or both of the legs 24/26 includes an identification member, which can be one or more surfaces of the leg, or a separate element associated with the leg, that is activated into a visible condition when a fastener F enters the chamber 34. Generally, the “visible” condition is defined with respect to a user of the tool viewing from above (i.e., proximate the upper/proximal end of the barrel or proximal to the nose assembly). In the depicted preferred embodiments, each of the identification members comprises a surface formed on one or more of the upright and oblique side surfaces, 40 and 42, and upper and side surfaces, 48 and 49, on each of the jaws 12 and 14; however, the number and configuration of the surfaces is non limiting. Ultimately, the exact surface at position of the identification member(s) on the respective jaw(s) is not critical provided that it is in a position to be viewable in the visible position.

As shown, the front arms 20 and 22 of the jaw members terminate in respective downwardly chamfered surfaces 28 and 30 that combine to form a receiving section for a tip of a fastener F. As depicted, the receiving section is preferably round or ovular to cooperate with the contour of the tip of the fastener. In this manner, it can be said that the chamfered surfaces combine to form an inverted quasi-conical receiving section. The jaws 12 and 14 are biased inwardly toward each other at the respective legs 24 and 26 and rotationally about the pins 18 such that the arms 20 and 22 are biased upward at their respective inner ends 28 and 30 (i.e., in the view of FIG. 6, the jaw member 12 is biased clockwise and the jaw member 14 is biased counterclockwise). The nosepiece 16 includes a lower stop 32 to define the rotational extent of each leg 24 and 26, which also defines the empty (unloaded) position of the jaws (i.e., no fastener is present) and the concealed condition of the identification members present on one or more of the surfaces 40, 42, 48 and 49. As can be seen most clearly in the enlarged cross-section of FIG. 8, in the embodiment of the identification unit 10, the bias member 46 comprises a resilient O-ring wrapped around the outer sections of each leg 24 and 26. The legs 24 and 26 may be fit with a lateral slot or notch 25 and 27 configured to receive and maintain a section of the O-ring. Notably, the bias member is not limited to an O-ring.

In some embodiments, the upper surfaces 48 and/or side surfaces 49 of the jaws have notification markings for providing a visual means of notifying an installer of absence or presence of a fastener F loaded into the barrel. The markings on the upper surfaces 48 and/or side surfaces 49 may be in lieu of or in addition to markings or paint on the other surfaces 40 and 42.

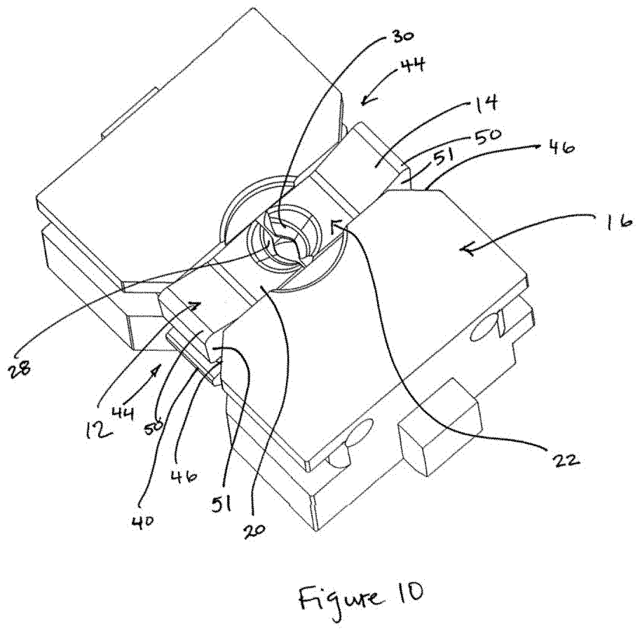

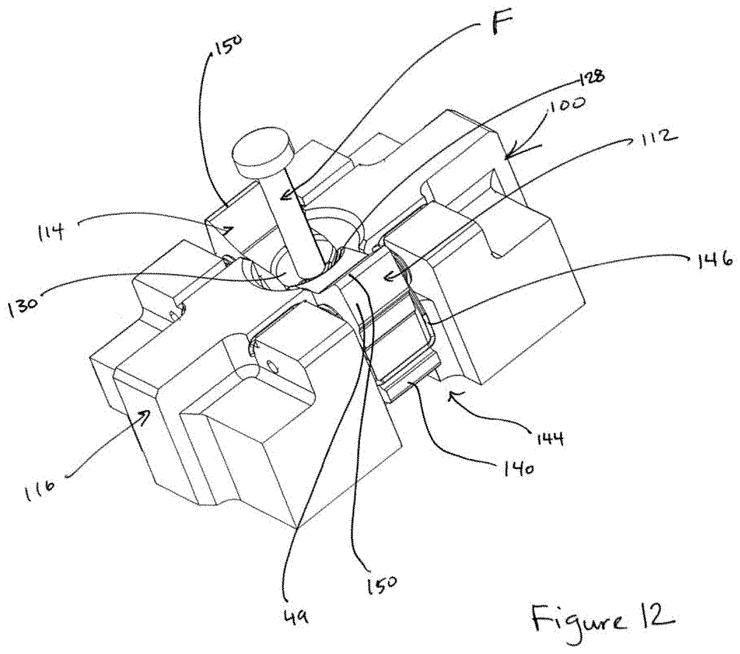

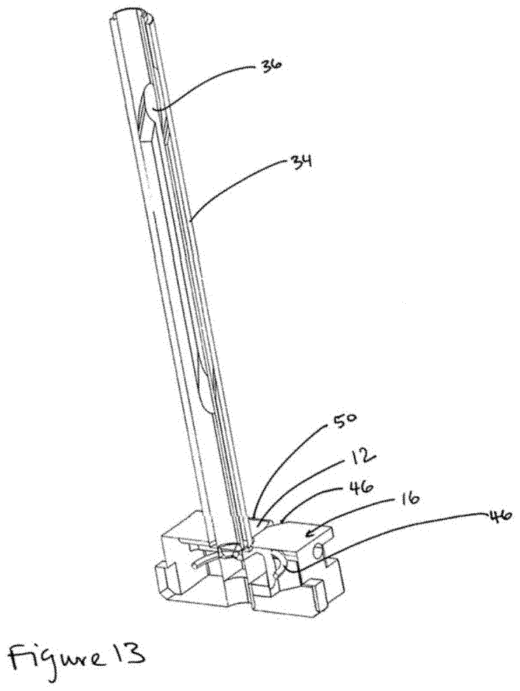

The tool 300 further includes a barrel 34 engaged with the nosepiece 16 substantially aligned with the receiving section defined by the center of the chamfered end surfaces 28/30 of the jaw arms. As shown, the barrel 34 is an elongated substantially cylindrical tube and may have one or more openings 36 in the wall of the tube sized and shaped to receive a fastener F to pass through the wall to the interior of the barrel 34. In other embodiments a wall opening 36 is omitted in favor of an inlet opening on the proximal end of the barrel 34. In operation, a user drops a fastener F tip first into a chute 35 with an outlet at the opening 36 such that the fastener F passes through the opening and into the barrel tip first, whereupon the fastener falls with the tip 102 received by the chamfered end surfaces 28/30. As the fastener F is received in this manner by the jaws 12 and 14, the jaws pivot outward (represented by rotational arrows in FIGS. 5A and 8) against the inward bias from a bias member 46. As noted above, in the embodiment of FIGS. 6-11 and 13, the bias member is an O-ring 46 wrapped around the outer surfaces of the legs 24 and 26. The embodiments shown in FIGS. 2, 5A-5C and 12 employ two opposing torsion springs 146 for biasing the respective legs 24 and 26 inwardly. Other embodiments of bias members exist, including operatively engaged compression springs or other compressible members, for example. The end surfaces 28/30 of the jaw arms are sized and shaped to engage the tip 102 to hold the fastener F upright in a driving position.

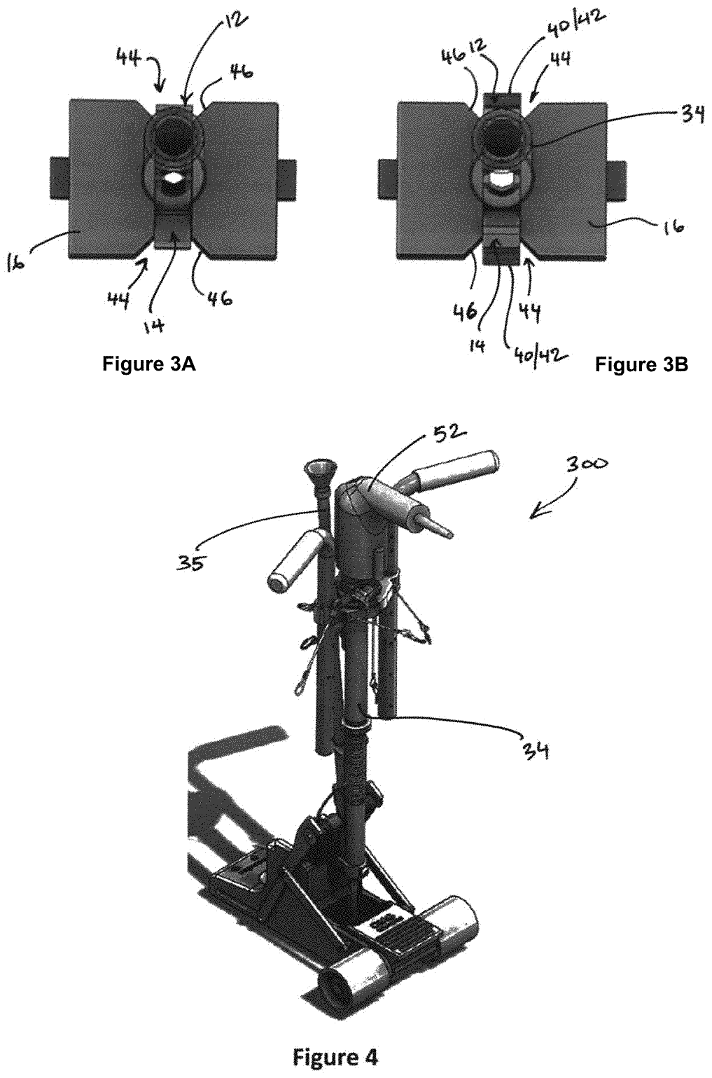

With primary reference to the top views of FIGS. 3, 7, 10 and 11, the nosepiece 16 includes a viewing window or notch 44 in each of the front and rear edges 46 with each notch 44 laterally aligned with a respective jaw 12 and 14. In other embodiments, the viewing window may simply comprise the rearward or forward area outside the respective edge of the upper portion of the nosepiece (or another portion of the tool in lieu of a nosepiece). In these embodiments, the identification member may be hidden from view beneath the upper portion of the nosepiece in the initial collapsed position without a fastener in the barrel, and is then exposed from beneath the upper portion via a fastener, when present.

With reference to FIGS. 3A, 3B and 5A-5C, when a fastener F is not present in the barrel 34 (unloaded), the jaws 12 and 14 are maintained in their inward position by the bias force of the bias member 46. In this embodiment in this position, the notification surfaces 40 and 42 are concealed from view from above (i.e., from proximal the distal end of the barrel or proximal the nosepiece) by the top surfaces 48 and the vertices 50 of the jaws 12 and 14. As explained above, the notification surfaces may be concealed by a portion of the tool or nosepiece. The unloaded position is shown generally in all Figures except FIGS. 3B, 5B and 5C. Actuation of the notification surfaces on one or more of the surfaces, 40, 42, 48 and 49, can best be seen with particular reference to FIG. 3, wherein the left side depicts the concealed position (no fastener present in barrel) and the right side depicts the expanded position (fastener loaded in barrel). Also of note is that embodiments exist wherein only one of the jaws is configured to pivot into an expanded position when a fastener is present in the barrel.

Once a fastener F is dropped into the barrel 34 via the chute 35, the tip 102 is received by the receiving section defined by the chamfered surfaces 28 and 30 of the arms 20 and 22. Receipt of the fastener tip in this manner causes the jaws 12 and 14 to pivot outwardly about the respective axis defined by the pins 18 against the force of the bias member 46 (see pivot arrows in FIGS. 5A and 8). In the loaded/driving position wherein a fastener F is loaded in the barrel 34, the side surfaces 40, 42 and 49 are pivoted slightly outward such that the surfaces become visible or at least change position when viewed from above through the viewing windows 44 of the nosepiece body 16. Similarly, the top surface 48 shifts position as the jaws 12 and 14 rotate. In one embodiment, one or more of the surfaces 40, 42 and 49 are painted a bright color or coated with a layer that is reflective or otherwise highly visible, while the top surface 48 may include a notification marking that changes position to notify the user when a fastener is loaded. Thus, an installer is notified of the presence of a fastener in the barrel simply by looking down and seeing the marked surface(s). A depiction of the expanded jaw position is shown in FIG. 3B. Conversely, when an installer does not see the surfaces 40, 42, 49, and/or the top surface notification is in its initial collapsed jaw position, he knows that a fastener is not loaded in the barrel and it is safe to drop a new fastener F into the chute 35 (left side of FIG. 3).

It is important to note that many specific embodiments of the identification unit exist that fall within the inventive scope of the disclosure. The identification surface need not be completely concealed from view in the collapsed position (unloaded), so long as a user can identify a visible shift in the identification member when a fastener is loaded. Additionally, in some embodiments, only one of the jaws is configured to provide such a notification. Unlike many known fastener identification systems, the disclosed embodiments are entirely mechanical in operation and additionally maintain a loaded fastener in an upright position for installation when loaded into the barrel.

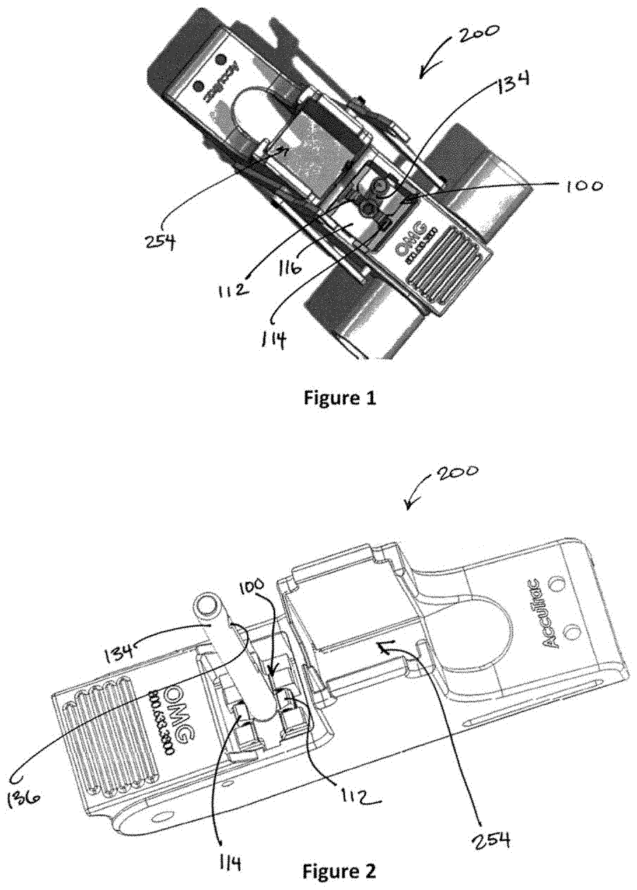

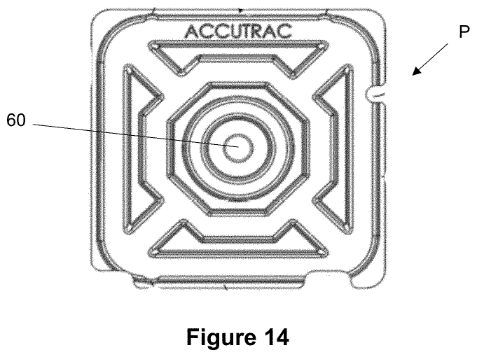

In a typical installation of a roofing plate P (see FIG. 14) via fasteners with the disclosed tool 300, a user initiates feeding of a roofing plate P into an attachment position with an attachment hole of the plate aligned with the barrel 34 of the tool. The plate P can be fed from a stack maintained in a plate sleeve 254 (see FIGS. 1 and 2) to the attachment position prior to or after dropping a fastener F into the loaded position in the barrel via the chute 35. An installer can look downward, and if the the identification surface(s) 40, 42, 49 and/or 48 or other identification member(s) indicate the collapsed/concealed position of the jaws, he knows that a fastener is not loaded in the barrel and it is safe to drop a new fastener into the chute without concern for jamming. Conversely, if the identification surface(s) 40, 42, 49 and/or 48 or other identification member(s) indicate the open or expanded position to the installer, he knows that a fastener is already loaded in the barrel 34 for driving and he refrains from dropping a second fastener into the chute 36.

Once a fastener is loaded into the barrel and the tool is operatively aligned for use, the installer initiates driving of the fastener, typically by activating a power driving drill 52 in communication with the fastener F to drive the fastener through a hole in the plate P and into a roof substructure to attach the plate, as is widely known in the art. When the fastener F is driven in this manner, the downward force from the drill overcomes the inward bias from the bias member (O-ring 46 or torsion springs 146 or other), thereby opening the jaws 12/14 and allowing the fastener to be driven past the jaws 12/14, through an aligned outlet opening 58 in the nosepiece body 16 or other member of the tool and into the roof substructure to attach the plate P. After the drill 52 is actuated back upward, the jaws 12/14 return to their closed position under the inward force of the bias member 46, thus, concealing the identification surfaces 40/42 from view from above and notifying the installer that a fastener F is not loaded in the barrel.

Notably, the depicted embodiment of the fastener identifying unit 10 include a nosepiece 16 distal of the barrel 34 with the jaws 12/14 rotatably attached to the nosepiece such that the jaws are rotatable relative to the barrel. However, alternative configurations exist wherein the jaws are rotatable relative to the barrel in other ways, provided that the jaws are positioned distal of the proximal end of the barrel (for a user to view from above). For instance, one or both jaws may attach directly to a portion of the barrel itself with at least a portion of the arms 20/22 positioned inward of the inner wall of the barrel for engagement with a fastener F, when present. In such embodiments, a nosepiece like that depicted as reference numeral 16 may optionally be omitted if appropriate for the intended use of the tool. Still further, different types of nosepieces or similar end units can be employed for use in different settings.

The shape, contour and positioning of the upper surfaces 48, side surfaces 49 and apex 50 above the axis of rotation 18 may define a nub 51 that allows a user to manually rotate the jaws 12 and 14 by pinching them inward toward each other by human action. This is useful if a fastener or multiple fasteners become jammed in the jaws 12 and 14.

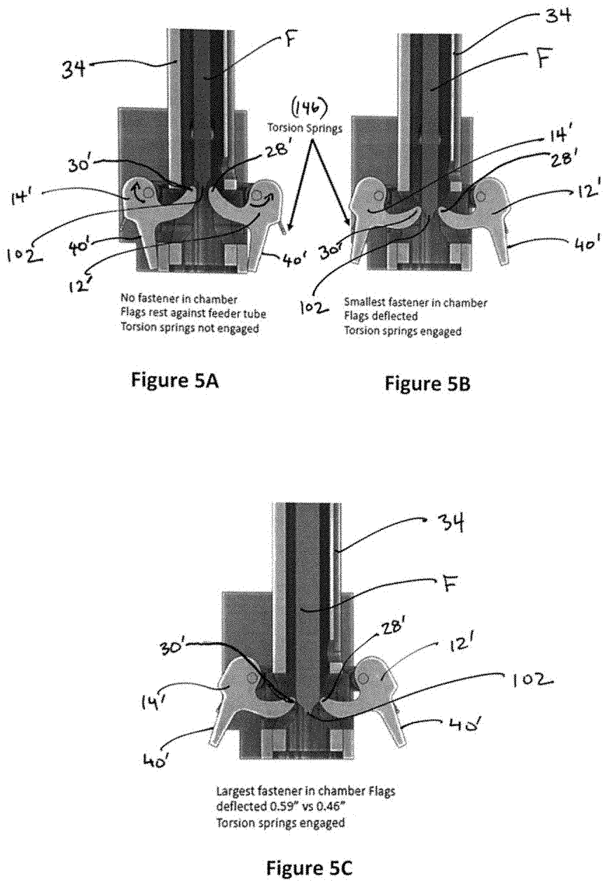

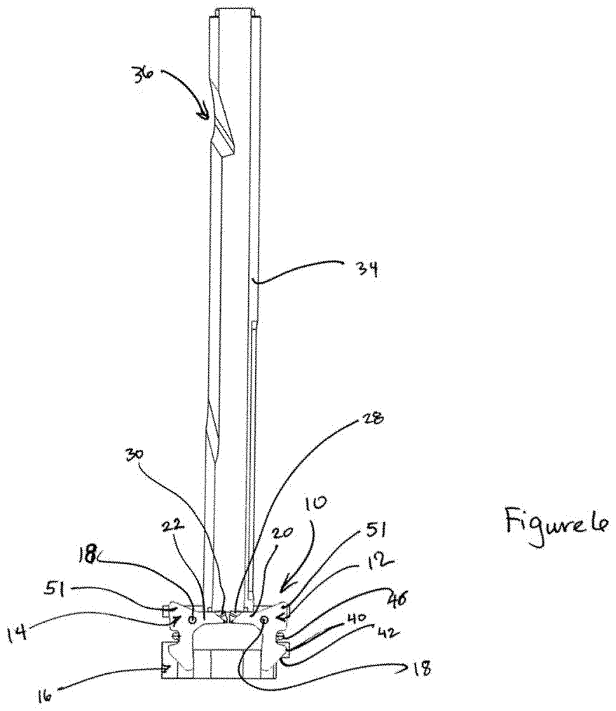

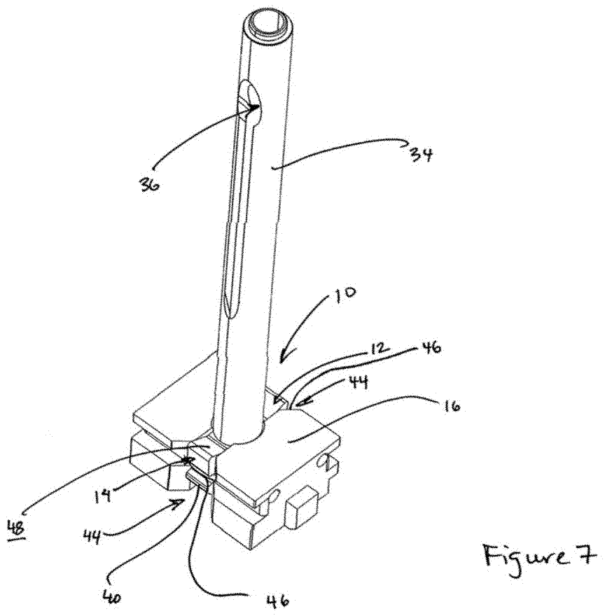

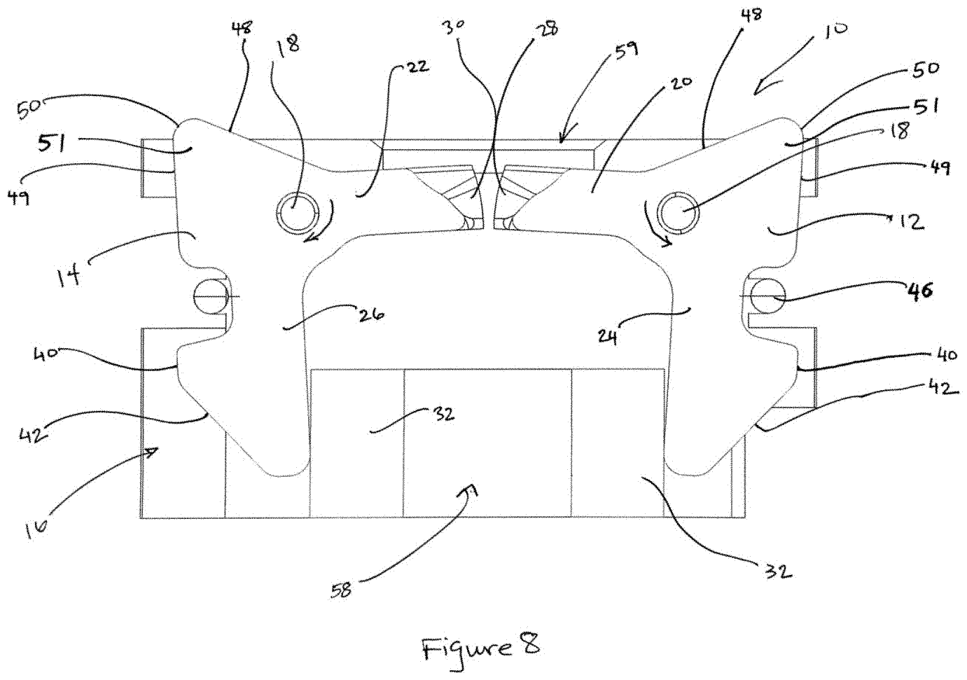

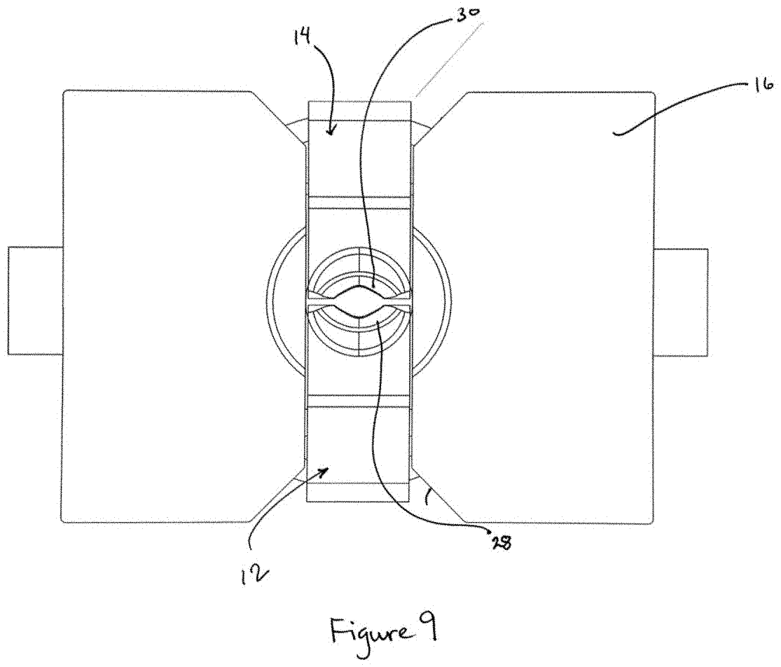

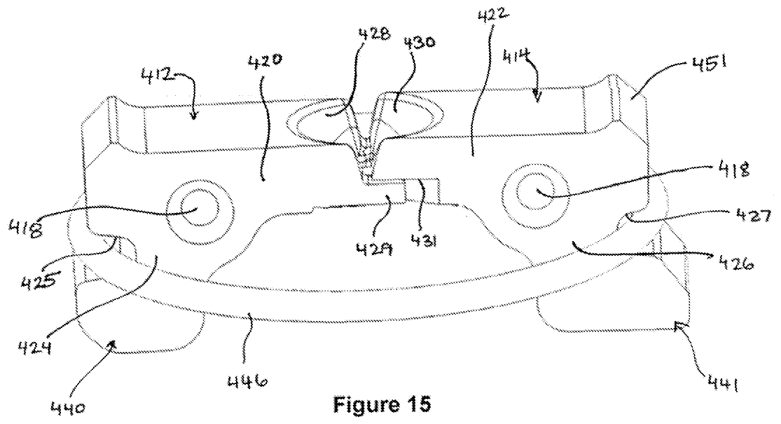

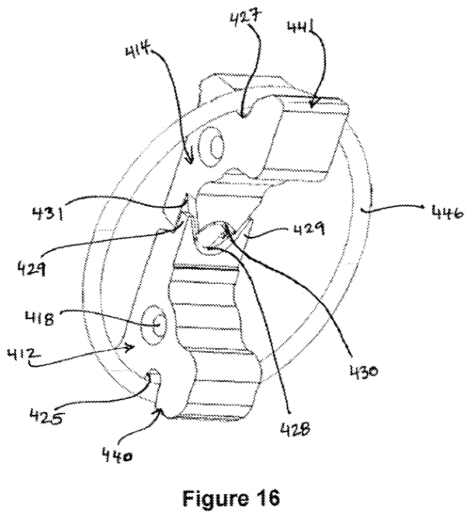

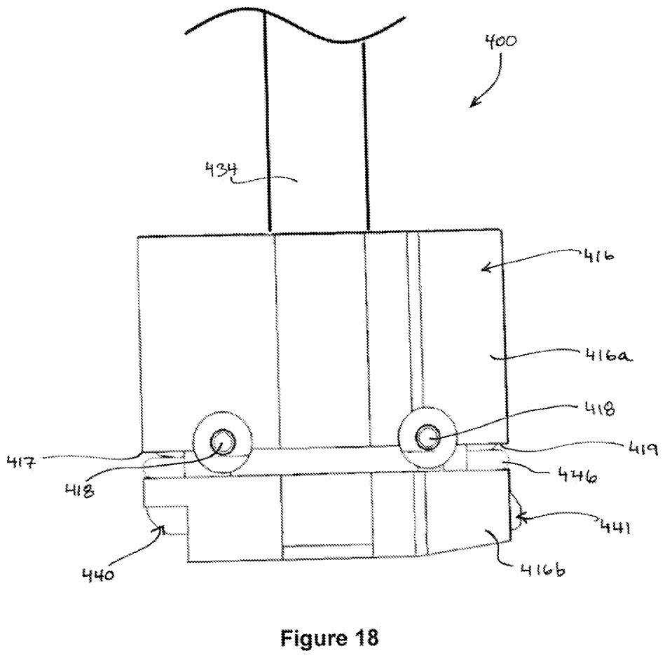

FIGS. 15-19 show yet another embodiment of the fastener identification unit 400. The general operation of this embodiment is substantially similar to those of FIGS. 1-13. With initial reference to FIGS. 15, 16, in this embodiment, the jaws 412 and 414 include laterally extending arms 420 and 422 extending from a respective upright leg 424 and 426, like the previous embodiments. However, in this embodiment, one arm 420 includes a front end 428 with finger sections 429 extending in the direction of the opposite arm 422 at a lower portion of the arm 420. The opposite arm 422 includes a front end 430 with a cooperative undercut 431 in its lower portion such that each of the fingers 429 nests within an undercut 431 when the jaws 412 and 414 are in the collapsed position without a fastener loaded. The nesting configuration of the fingers 429 and undercut 431 in this embodiment allows overlapping between the respective jaws in the region of the fastener receipt section. This overlapping configuration has been shown to provide a greater degree of relative movement of the jaws when a fastener is loaded, which is especially useful when loading fasteners of relatively smaller dimensions.

Remaining elements, relationships and operational features of this embodiment of the fastener identification unit 400 overlap with the earlier embodiments of FIGS. 1-13. For example, the fastener identification unit 400 includes a bias member 446, which in the depicted preferred embodiment, comprises an O-ring wrapped around the outer sides of the legs 424 and 426, and received within a notch 425/427 in each leg to maintain the O-ring in position. The bias member 446 biases the legs 424 and 426 inward and the arms 420 and 422 upward, i.e., in FIG. 15, the jaw 414 on the right side is biased about its pin 418 in the clockwise direction and the jaw 412 on the left side is biased about its pin 418 in the counterclockwise direction.

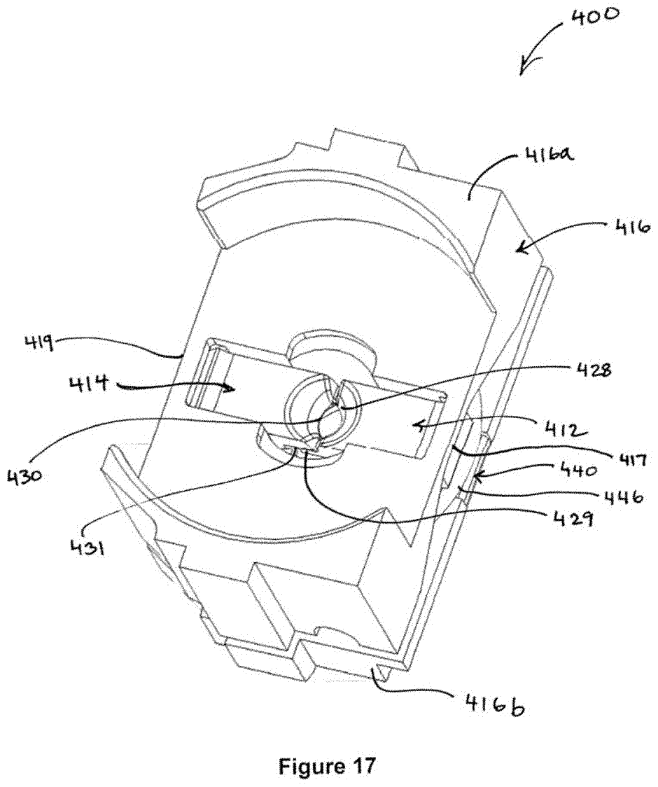

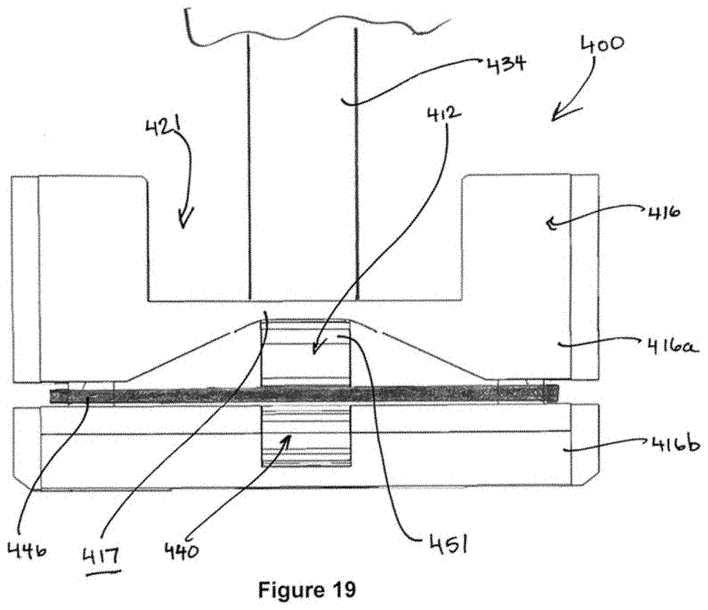

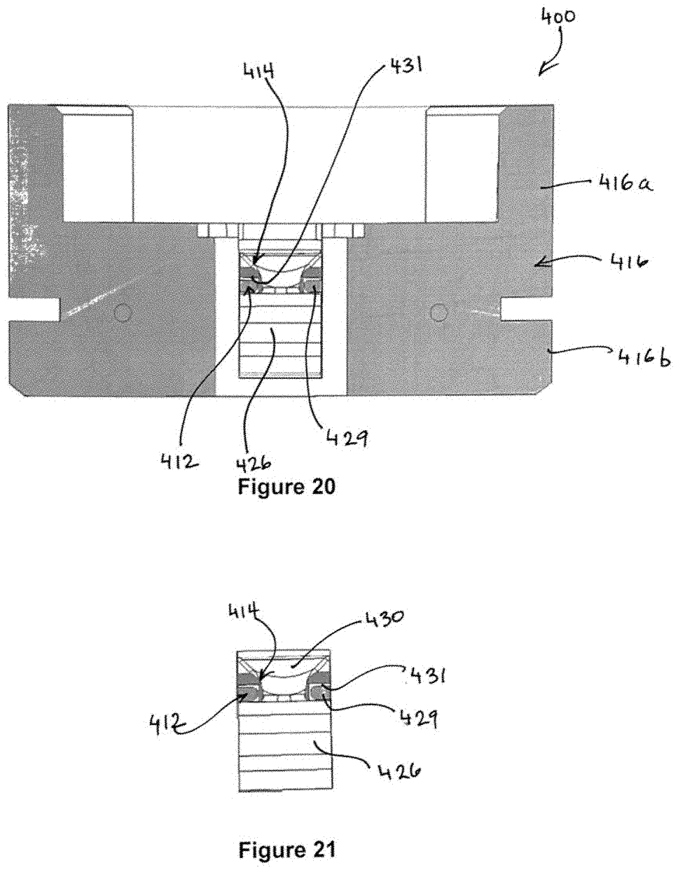

As shown in the view of FIGS. 17 and 19, the nosepiece 416 may include an upper portion 416a and a lower portion 416b with the upper portion 416a defining a seat 421 for receipt of a distal end of the barrel 434 in a nested engagement. While not shown in the drawings, the barrel 434 may additionally include a distal fitting or similar element to assist a robust nested engagement within the seat.

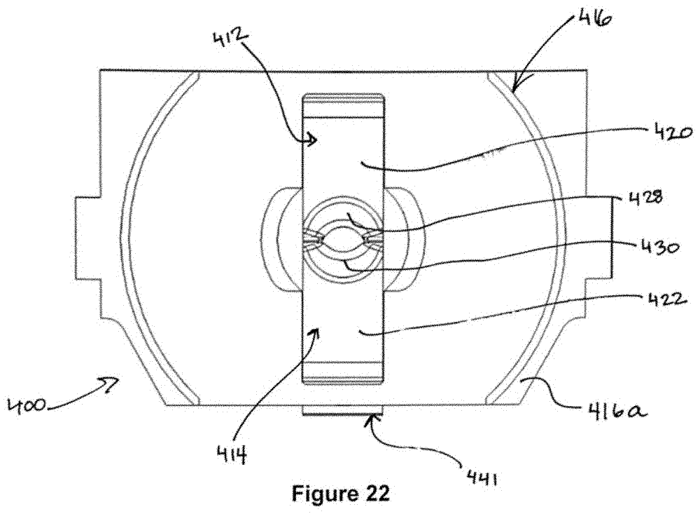

Additionally, shown most clearly in FIGS. 15, 16 and 22, in this embodiment, the identification member(s) can come in the form of one or more feet, 440 and/or 441, proximate the bottom of a respective leg. Also shown is that each of the jaws can include a foot (proximate the bottom of the respective leg) that is not identical to the other foot. Here, one foot 440 on the jaw 412 has a relatively smooth rounded contour, while the foot 441 on the jaw 414 has discrete surfaces and edges with a portion that projects laterally outward. In this embodiment, when a fastener is not loaded, the rounded foot 440 is configured to be hidden from view beneath the upper portion 416a of the nosepiece 416 in its concealed first position, while the other foot 416b projects slightly outward from beneath the outer edge 419 of the upper portion 416b in its first position, however, this is a non-limiting characteristic. In use, typically, the completely hidden foot 416a is on the front side of the tool 300 in the downward sightline of the user, and the projecting foot 416b is on the rear side of the tool 300, toward the user's foot.

Upon loading a fastener F into the barrel, the tip of the fastener is received by the receiving section defined between the front edges 428 and 430 of the respective arms 412 and 414. This causes the jaws to pivot against the bias force of the bias member 446 and the feet 440 and 441 to shift outward from their respective first positions to a respective expanded second position. In its second position, the foot 440 is exposed from beneath the upper portion 416a of the nosepiece to notify the user that a fastener is present within the barrel. In this manner, the “viewing window,” referenced above is merely the area outside the outer edges, 417 and 419, of the upper portion 416a of the nosepiece.

The above described overlapping configuration of the fingers 429 and undercut 431 has shown significant efficacy in providing greater degree of relative pivoting movement between the jaws 412 and 414. More specifically, the first jaw 412 with fingers 429 pivots a greater degree than the second jaw 414 in this configuration. Again, this configuration has shown to be especially useful with a relatively smaller sized fastener that may otherwise not initiate sufficient pivoting action of the jaws to notify the user of its presence in the barrel.

Like earlier embodiments, one or both of the jaws, 412 and 414, may include an upper nub, 451, above the axis formed by the pin 418 to allow a user to manually open the jaws by pinching them toward each other to release a jammed or unwanted faster. As shown in FIG. 19, the one or more nub 451 is accessible to the user for actuation, if necessary.

In a preferred embodiment of the fastener identification unit, 10, 100, 400, one or both of the jaws is formed from a metal or metal alloy or another durable material. Aluminum has shown to contribute to improved movement of the jaws given its relatively light weight compared to other metals, like steel, for example. The jaws may be treated or coated with a hardening material for enhanced durability.

Additionally, while the disclosed embodiments include a pair of jaws that actuate via rotation about an axis pin, other embodiments exist that employ different mechanisms for actuation. For example, one or more jaws or similar members may move outward substantially linearly against an inward bias force. Other embodiments may include one or more jaws that rotate about an axis that is upright rather than horizontal (in the views shown in the drawings).

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

What is claimed is:

1. A tool with a barrel for driving fasteners, the tool having a top and a bottom, comprising:
a fastener identifying unit positioned toward the bottom of the tool and having two opposing jaws attached in a pivotal relationship relative to one another, at least one opposing jaw including an identifying portion on a surface threof, wherein
the opposing jaws are biased toward a closed position in which the identifying portion is in a first position,
when a fastener is absent from the barrel of the tool, the jaws are maintained in the closed position, and
when a fastener is present in the barrel of the tool, the fastener mechanically causes the at least one jaw that includes the identifying portion to pivot relative to the other jaw from the closed position against the bias to an opened position with the identifying portion in a second position viewable by an individual from a position toward the top of the tool.

2. The tool of claim 1, wherein the identifying portion is concealed from view by an individual from the position toward the top of the tool in the first position.

3. The tool of claim 1, wherein the identifying portion is a reflective material or coating on the respective surface on which it is located.

4. The tool of claim 1, wherein the biasing force is provided by a bias member selected from an O-ring wrapped around a portion of the jaws and a torsion spring.

5. The tool of claim 1, wherein the biasing force is provided by weighting in portions of the jaw members acted upon by gravity.

6. The tool of claim 1, wherein driving of the fastener by a bit of the tool causes further expansion of the jaws against the bias to a driving position that allows the fastener to be driven from the barrel and into a building member by the bit.

7. The tool of claim 6, wherein retraction of the bit into the barrel after driving the fastener into the building member allows the jaws to return to the closed position under the bias.

8. The tool of claim 1, wherein one or both of the jaws comprises a nub proximate an apex that allows a user to mechanically pivot the jaws outward by human action via application of a force on the nub.

9. The tool of claim 1, wherein each jaw has a generally L-shaped cross section with a respective front arm and a respective lower leg and are configured as substantially mirror images of one another with each front arm including a respective front edge that opposes an opposite front edge of the front arm of the other jaw, the front edges combining to define a receiving section for a tip of a fastener.

10. The tool of claim 9, wherein when a fastener is present in the barrel, the tip is received by the receiving section, thereby causing the jaws to pivot outward from the closed position to the opened position.

11. A tool for driving fasteners into a building member, comprising:
an elongate barrel with a top proximal end and an opposite distal outlet proximate a nosepiece;
two opposing jaws positioned toward the distal outlet, each jaw having an opposing edge aligned with the outlet, at least one jaw being pivotable relative to the barrel and defining an identification member, wherein
when a fastener is present in the barrel with a tip portion at the outlet, the fastener mechanically causes the pivotable jaw to pivot outward from a first position to a second position to expose at least a portion of the identification member for view by a user from a position toward the top proximal end of the barrel, thereby notifying a user that the fastener is present in the barrel.

12. The tool of claim 11, wherein the jaws are pivotally attached to the nosepiece distal of the outlet of the barrel.

13. The tool of claim 11, wherein the nosepiece includes a viewing window through which the identification member is visible by a user from the top proximal end at least in the second position.

14. The tool of claim 11, wherein the opposing jaws are completely distal to the outlet.

15. The tool of claim 14, wherein the opposing jaws are secured to the nose piece in a pivotable engagement.

16. The tool of any one of claims 11, wherein the jaws have a substantially L-shaped cross-sectional shape, each jaw comprising a front arm extending inward from a lower leg.

17. The tool of any one of claims 11, wherein each jaw comprises a nub proximate an apex between the front arm and lower leg and the jaws can be rotated via pinching the nubs inward.

18. The tool of any one of claims 11, wherein the pivotable jaws are biased into an inward rotational position with one or more of the identification members concealed from view from above.

19. The tool of claim 1, wherein a portion of a first of the jaws overlaps a portion of a second of the jaws in the first position.

20. The tool of claim 1, wherein a first of the jaws includes a finger extending from an arm in the direction of a second of the jaws, and the second of the jaws includes a notch in an arm beneath which the finger nests in the first position.

21. A tool for driving fasteners into a building member, comprising:
an elongate barrel extending from a proximal end to a distal end with an outlet and defining a longitudinal axis;
a first jaw and a second jaw positioned distal of the proximal end, the first jaw having a first edge and the second jaw having a second edge opposing the first edge at an interface defining a fastener receipt section substantially aligned with the longitudinal axis, one or both of the first jaw and second jaw being shiftable relative to the barrel, the one or both of the first jaw and second jaw that is shiftable defining an identification member, wherein
when a fastener is received within the barrel, a tip portion of the fastener engages the receipt section, thereby causing the one or both of the first jaw and second jaw that is shiftable to shift with the identification member moving outward from a first position to a second position, wherein the moving of the identification member to the second position is viewable by a user from the proximal end of the barrel, thereby notifying a user that the fastener is present within the barrel.

22. The tool of claim 21, wherein one or both of the first jaw and the second jaw is biased toward the first position.

23. The tool of claim 21, wherein the one or both of the first jaw and second jaw that is shiftable is pivotally secured to the tool.

24. The tool of claim 21, wherein the first jaw is chamfered at the first edge and the second jaw is chamfered at the second end to define the receipt section.

25. The tool of claim 21, wherein each of the first jaw and the second jaw is pivotal relative to the barrel.
